(19) United States
(12) Patent Application Publication
(10) Pub. No.: US 2011/0208434 A1
(43) Pub. Date: Aug. 25, 2011

(54) METHOD AND SOFTWARE FOR CARDIOVASCULAR ASSESSMENT AND RISK DETECTION

(76) Inventor: Steven H. Hersh, Riverwoods, IL (US)

(21) Appl. No.: 13/027,251

(22) Filed: Feb. 14, 2011

Related U.S. Application Data
(60) Provisional application No. 61/304,118, filed on Feb. 12, 2010.

(51) Int. Cl. G06F 19/00

(52) U.S. Cl. 702/19

(57) ABSTRACT

The present invention provides an improved comprehensive method of assessing an individual's risk of developing CVD through analysis of multiple factors know to be associated with the development of cardiovascular disease. The factors include the classic Framingham factors of an individual's age, blood pressure, total cholesterol (TC), high-density lipoprotein (HDL) cholesterol, history of diabetes and history of cigarette smoking, in addition to factors know to be associated with increased risk of CVD including inflammation, insulin resistance, obesity, kidney dysfunction.

### CROSS REFERENCE TO RELATED APPLICATIONS

This application claims the benefit of U.S. Provisional Patent Application 61/304,118 filed Feb. 12, 2010, which is herein incorporated by reference.

### BACKGROUND OF THE INVENTION

1. Field of Invention

The present invention relates to methods and software for assessing an individual's risk of developing cardiovascular disease.

2. Discussion of Relevant Prior Art

The term cardiovascular disease (CVD) broadly refers to a range of diseases that affect the heart and blood vessels. Although coronary heart disease is most commonly associated with cardiovascular disease, the scope of the term also includes other disorders of the heart or blood vessels such as, arteriosclerosis, heart valve disease, arrhythmia, heart failure, hypertension, diseases of the aorta and its branches, and disorders of the peripheral vascular system.

Despite increased focus on primary prevention and efforts to educate individuals about ways to reduce their risk for developing cardiovascular disease, CVD continues to be the leading cause of death of men and women over the age of forty. Because of this reality, greater emphasis has been placed on identifying individuals at risk for developing CVD with the hope of intervening at a time when lifestyle modification or drug therapy may be beneficial in preventing the onset of disease.

Cardiovascular risk factors are broadly defined as measureable elements which population studies have shown to be associated with the possible development of cardiovascular disease in an individual. The presence of factors such as increased age, obesity, high blood pressure and high triglyceride levels are known to increase an individual's risk of developing CVD as compared to the studied population. Although the presence or absence of each risk factor may be examined separately, a multifactor assessment tool is believed to provide a more accurate picture of an individual's overall CVD risk.

One of the first and most widely used multifactor risk assessment tools is the Framingham Global Coronary Heart Disease (CHD) Risk Assessment (Framingham Assessment). The Framingham Assessment is based on a long term study of a population of individuals that relates an individual's age, blood pressure, total cholesterol, high-density lipoprotein (HDL) cholesterol, history of diabetes and history of cigarette smoking to a quantitative risk of having CHD within ten years. The Framingham Assessment is applied by first calculating the risk level for each individual risk factor and then assigning points to the risk level for each separate risk factor. The points for all the individual risk factors are then totaled and then compared to the Framingham Assessment scale which assigns an overall risk percentage based upon the point total for the individual risk factors.

Although the Framingham Assessment provides a simple and consistent method of assessing an individual's risk of developing CHD, it does not provide a comprehensive assessment tool that includes CVD risk factors identified subsequent to the creation of the Framingham Assessment. Furthermore, the Framingham assessment does not consider how the presence of certain risk factor combinations, such as inflammation and insulin resistance, impacts the overall risk score.

### BRIEF SUMMARY OF THE INVENTION

The present invention is directed to an improved, manual or computer-implemented method of assessing an individual's risk of developing cardiovascular disease within 10 years of the assessment and a computer program product for use in the assessment. More specifically, the present invention provides a comprehensive method of assessing an individual's risk of developing CVD through analysis of multiple factors know to be associated with the development of cardiovascular disease. The factors include the classic Framingham factors of an individual's age, blood pressure, total cholesterol (TC), high-density lipoprotein (HDL) cholesterol, history of diabetes and history of cigarette smoking, in addition to factors know to be associated with increased risk of CVD including inflammation, insulin resistance, obesity, kidney dysfunction. Data relating to each of these risk factors for an individual is collected through simple, non-invasive and highly portable methods including; a cardiovascular directed personal history, blood pressure reading, standard measurements of height and weight to derive a Body Mass Index (BMI), and measurement of the waist and hips to calculate the waist/hip ratio. In addition, blood is drawn to assess the individual's High-sensitivity C-reactive protein (HSCRP), glycated hemoglobin (HbA1C), (TC)/HDL/Non-HDL and low-density lipoprotein (LDL) levels, and possibly brain natriuretic peptide (BNP). Urine is tested for protein excretion as microalbuminuria (MA). Measurement of brachial blood pressures to compare to the Ankle-Brachial Index (ABI) and Carotid Intima-Media Thickness (CIMT) may also be assessed and a standard 12 lead Electrocardiogram (EKG) may also be performed.

After the data relating to each factor is collected, the risk level for each factor is quantified based upon the known risk levels categorized for each test. The individual risk scores are then adjusted to quantify enhanced risk resulting from specific combinations of factors, such as inflammation and insulin resistance, that combine to increase the overall CVD risk, as compared to the individual risk scores generated if each risk factor was assessed alone.

The adjusted risk scores for all the individual tests are then added together to obtain an overall score for the individual which is interpreted through the Framingham Assessment scale. The overall score may be enhanced by further refining the score with the individual risk scores relating to CIMT, ABI, EKG and BNP.

As will be appreciated by those of skill in the art in light of the present disclosure, embodiments of the present invention may include methods, systems, apparatus and/or computer program products or combinations thereof.

The foregoing and other objects and aspects of the present invention are explained in detail in the specification set forth below.

### BRIEF DESCRIPTION OF THE DRAWINGS

FIG. 1 is a table listing the risk factors evaluated and assessed in the present method.

FIGS. 2a and 2b is a flow chart of the steps comprising the method.

FIG. 3 is a table for males and a table for females listing the 10 year risk assessment percentiles used to evaluate the total score derived from the present method.

FIG. 4 is a flow chart of risk factors and steps that may be added to the steps disclosed in FIGS. 2a and 2b.

FIGS. 5a, 5b, 5c, and 5d depict a flow chart of the method, tables and point calculation scoring steps and requirement male subjects.

FIGS. 6a, 6b, 6c and 6d depict a flow chart of the method, tables and point calculation scoring steps and requirement female subjects.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

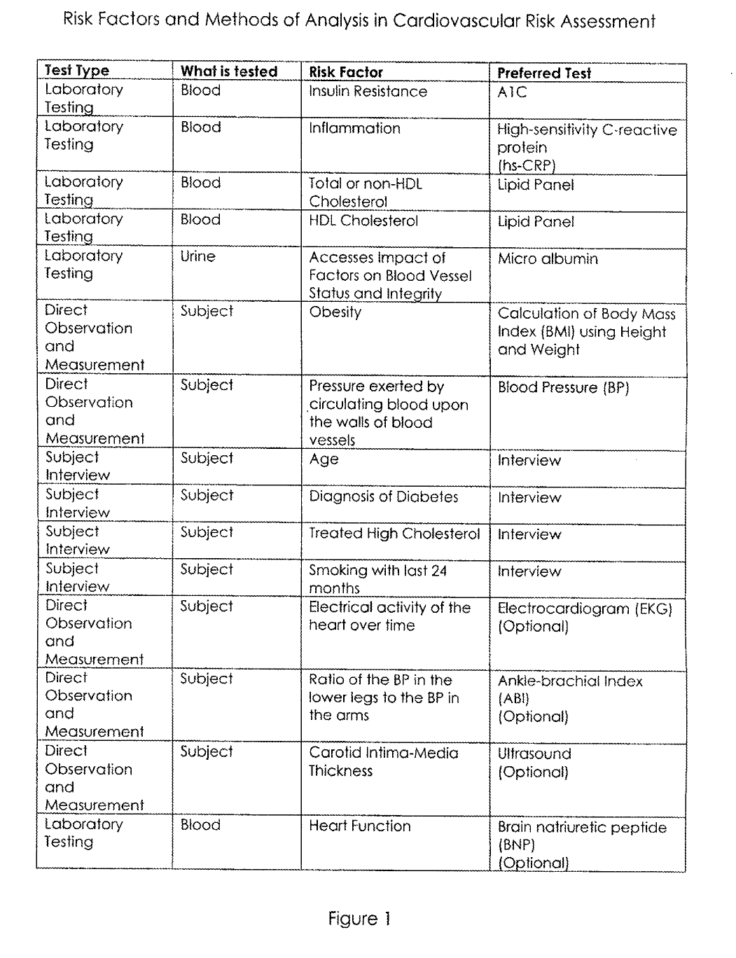

Referring now to FIG. 1, the present invention is directed to an improved method of assessing an asymptomatic individual's risk of a developing cardiovascular disease within 10 years of the assessment. The method includes the analysis of data relating to multiple cardiac risk factors including; age, family history, smoking history, total cholesterol levels, HDL cholesterol levels, non HDL cholesterol levels, body mass index, microalbumin levels, blood pressure, insulin resistance, and inflammation levels.

In addition, risk relating to CIMT, ABI, EKG and BNP may also be consider.

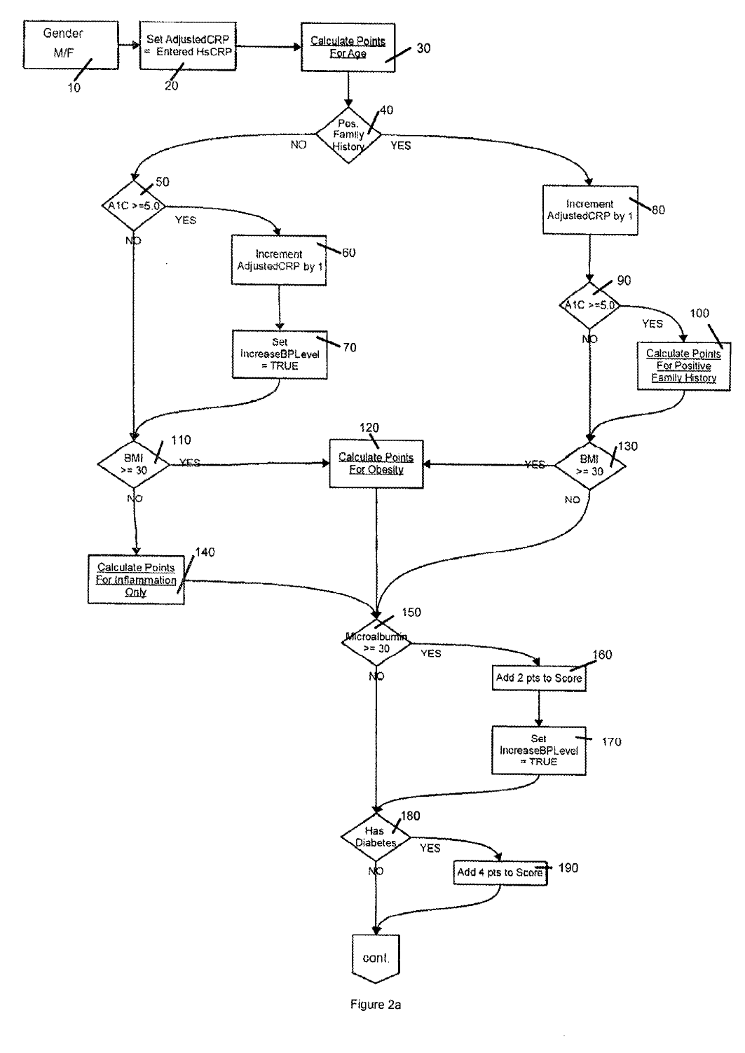

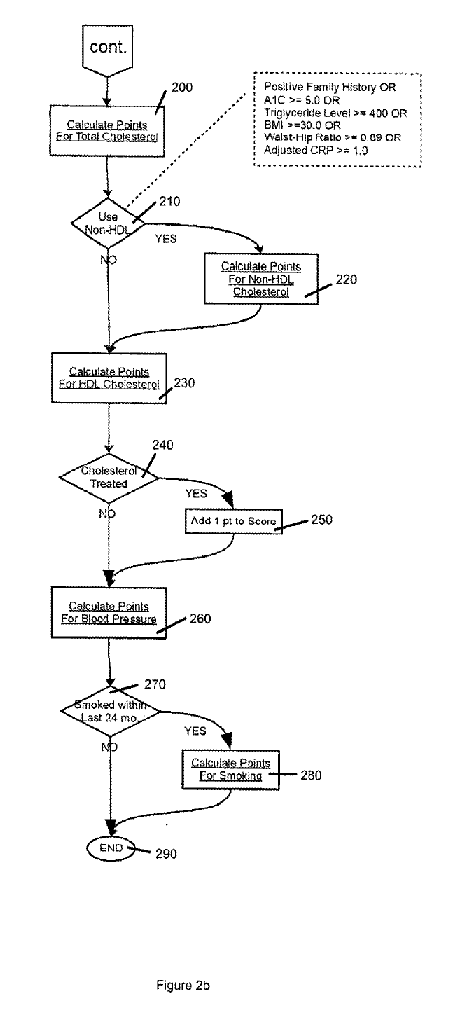

The data relating to each risk factor is collected and assessed to determine the risk relating to each individual factor. Although it is preferable to collect all the relevant data contemporaneously, it is not essential. The collected data is then classified, adjusted and categorized through the steps shown in FIGS. 2 through 6. Although this method may be completed manually, the use of a computer-implemented method through the associated computer program product is preferred.

The flowcharts and block diagrams of certain of the figures herein illustrate the architecture, functionality, and operation of possible implementations of analysis models and evaluation systems and/or programs according to the present invention. In this regard, each block in the flow charts or block diagrams represents a module, segment, operation, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved.

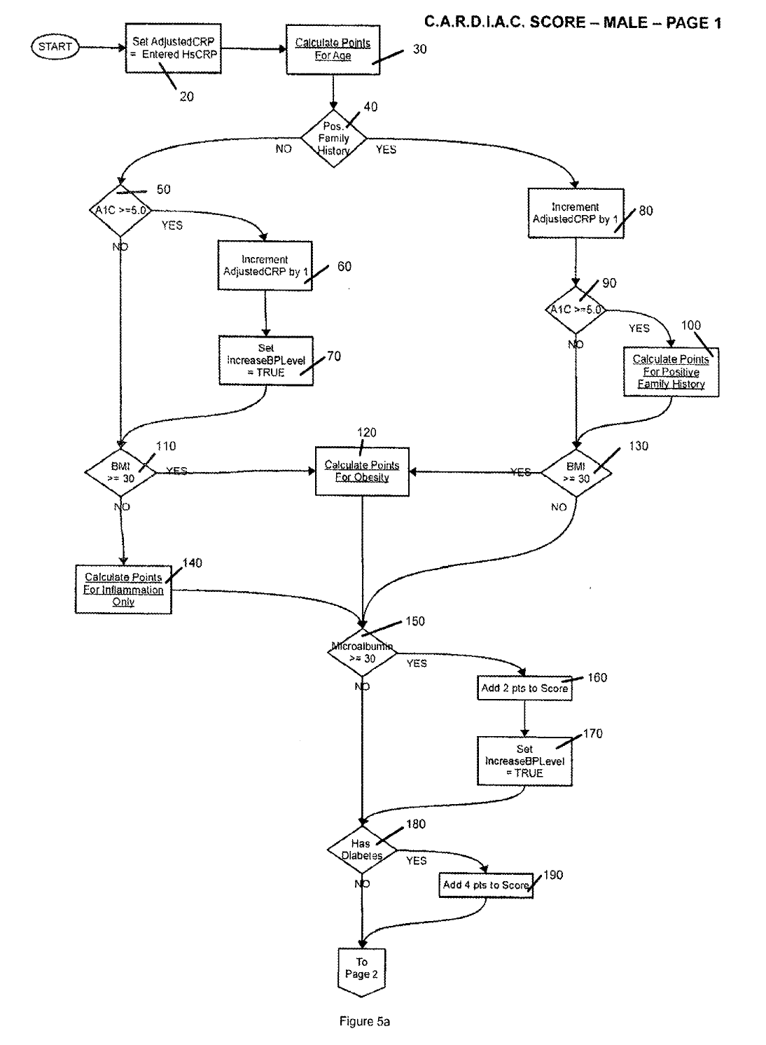

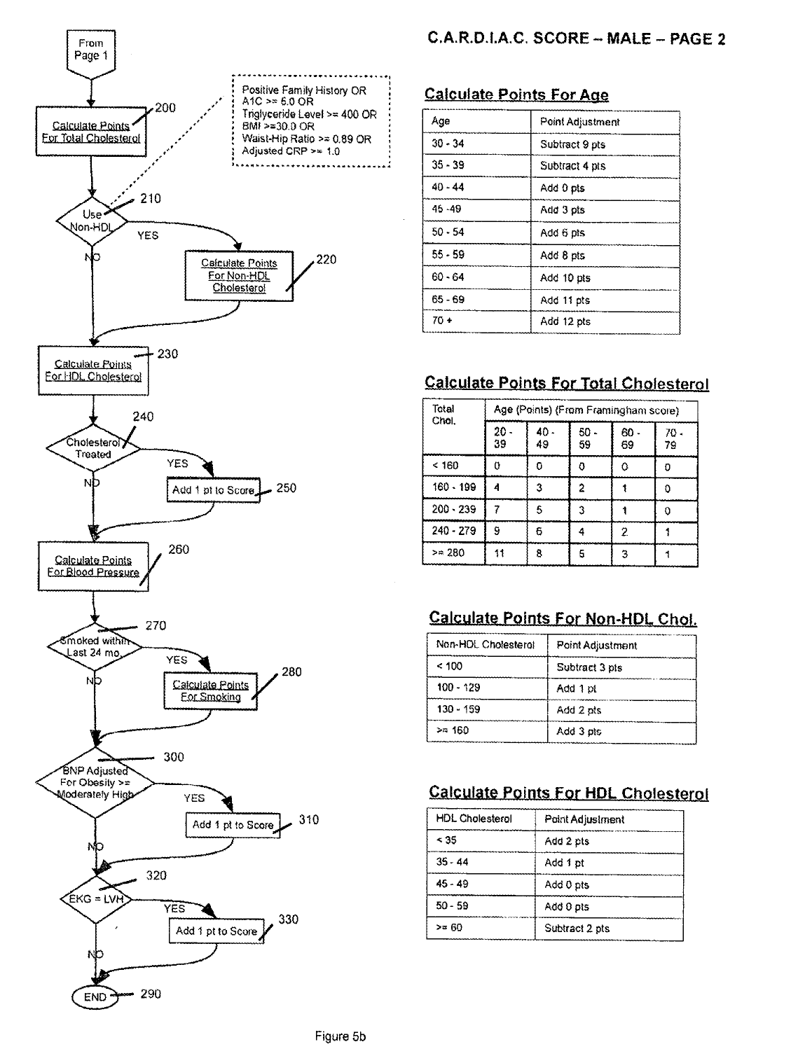

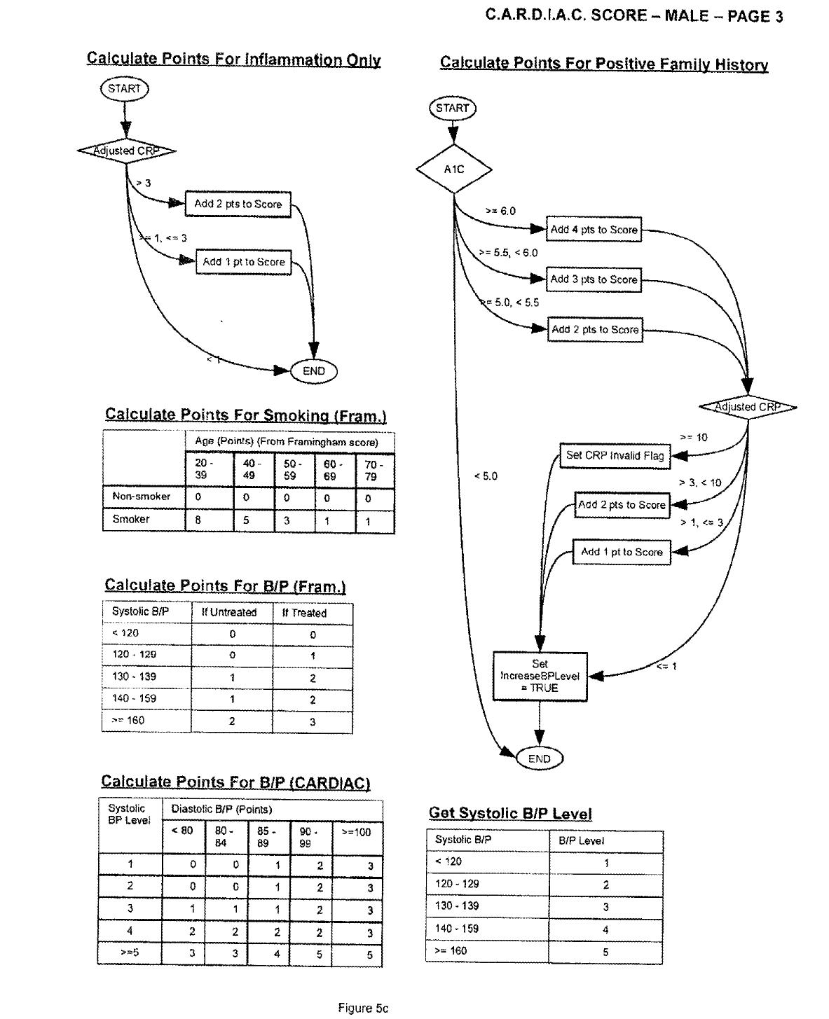

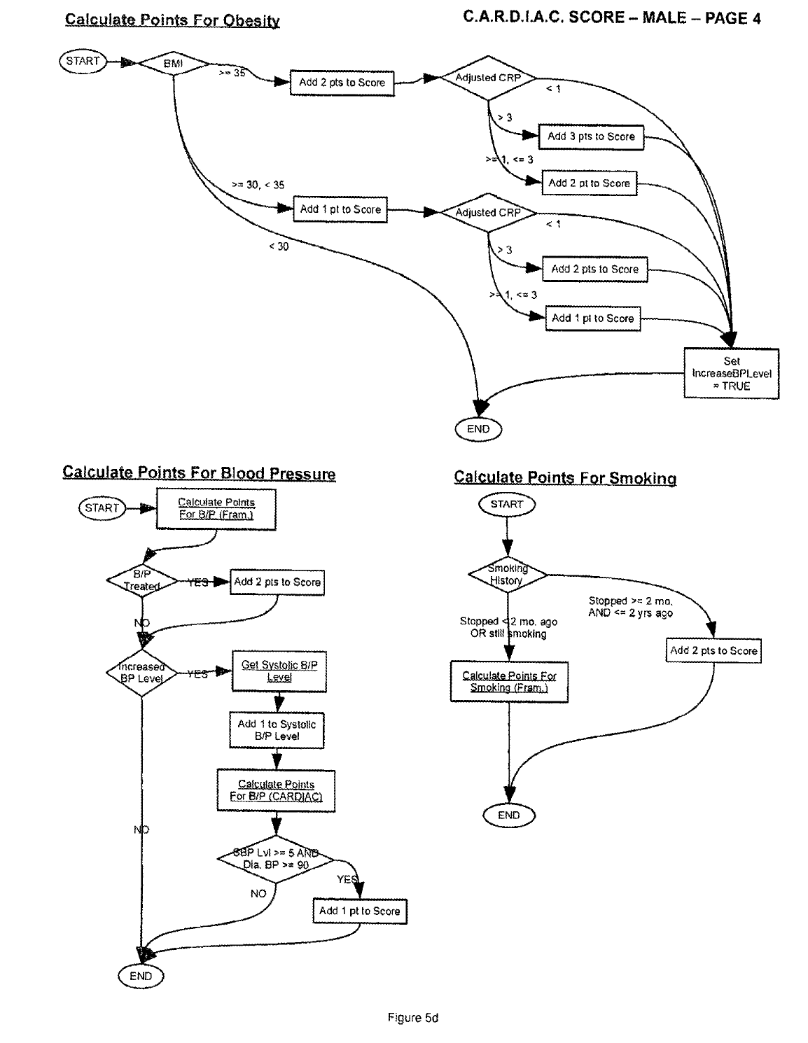

FIGS. 2a-b, 3, 5 a-d and 6 a-d illustrate flow charts of the computer-implemented method comprising the following steps. As shown in FIG. 2a, data regarding the gender of the individual is entered 10. If the individual is male, the risk score is determined through the process illustrated in FIGS. 2 a-b and 5 a-d. The individual is female, the risk score is determined through the process illustrated in FIGS. 2 a-b and 6 a-d. After the gender data is entered, data regarding HsCRP 20 is entered for use in adjusting additional factors. Points for the age of the individual are then assigned 30 in accordance with the rankings provided in FIGS. 5b (for men) and 6b (for women). Data relating to the individual's family history of CVD is then assessed 40. If the individual does not have a positive family history of CVD, the individual's insulin resistance in evaluated 50. If an A1C level greater than or equal to 5.0 is detected, the HsCRP score is increased by 1 point 60 and the SBP level is increased by one level 70. If the Family History 40 is positive for CVD then the HsCRP score is increased by 1 point 80 before evaluating the insulin resistance.

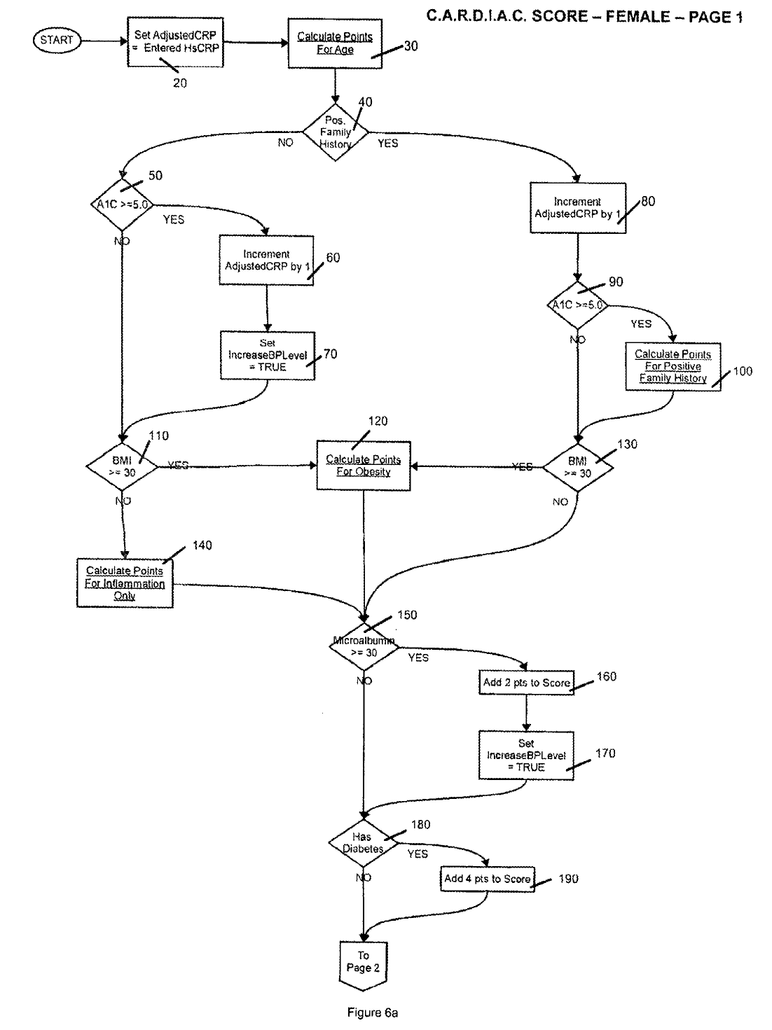

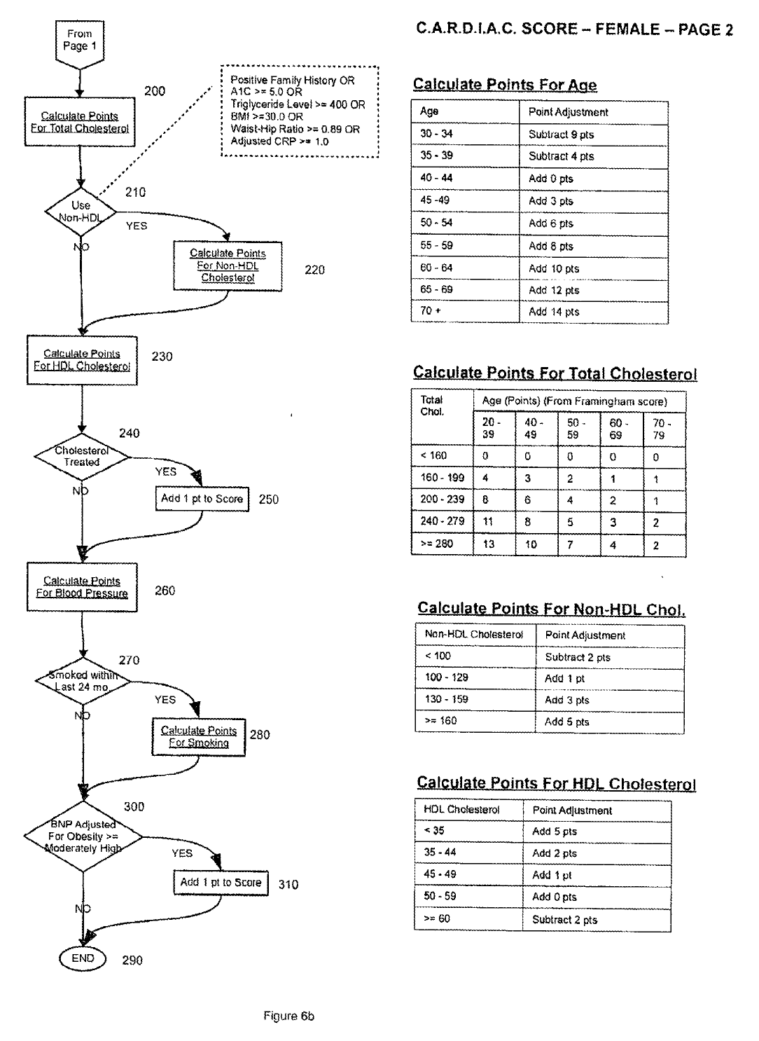

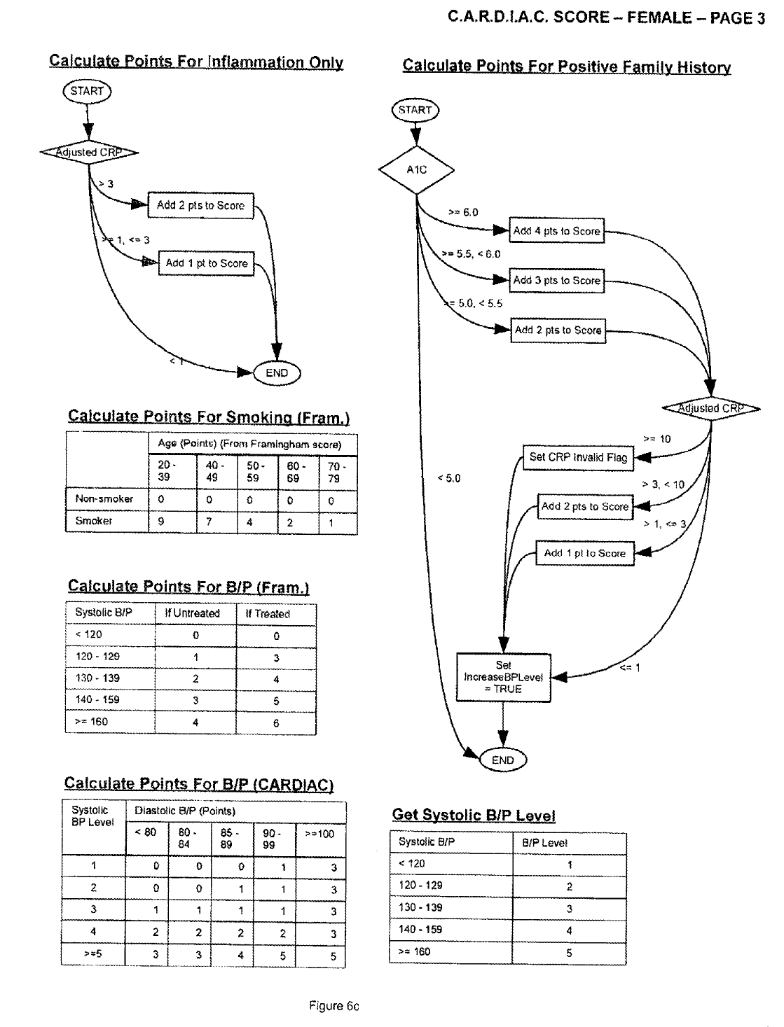

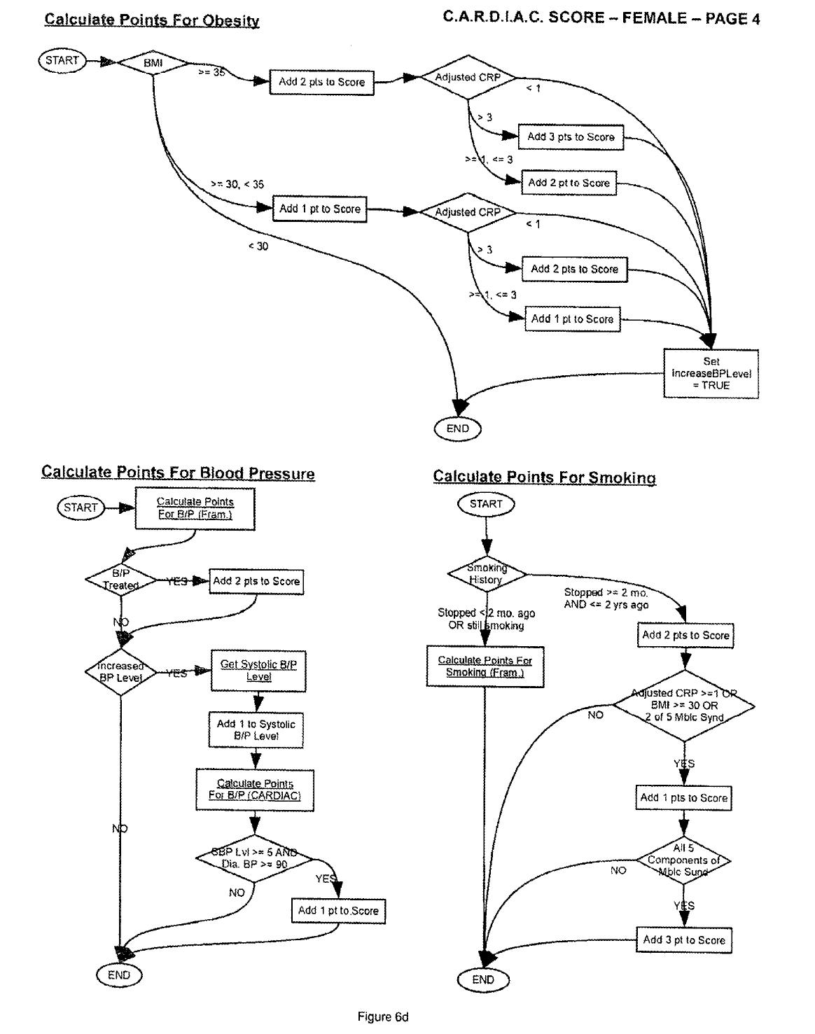

If the A1C level 90 is greater than or equal to 5.0, then points for a positive family history 100 are calculated as shown in FIG. 5 c (for men) and FIG. 6 c (for women). Data relating to the individual's BMI 110 or 130 is then considered. If the individual does have a BMI greater than or equal to 30, points for obesity 120 are calculated as shown in FIGS. 5 d (for men) and 6 d (for women).

If the individual does not have a family history of CDV and does not have a BMI greater than or equal to 30, points relating to “inflammation only” 140 are calculated in accordance with the steps shown in FIGS. 5 c (for men) and 6 c (for women).

Data relating to Microalbumin is then evaluated 150. If the MA level is greater than or equal to 30, two points are added to the overall risk score 160 and increase the SBP level by one 170.

Data relating to the individual's history of diabetes is then evaluated 180. If a positive history is present, four points are added to the score 190.

Data relating to total cholesterol 200 is then evaluated and the related points are calculated as shown in FIGS. 5b (for men) and 6b (for women). If the individual has a positive family history of CVD OR has an A1C greater than OR equal to 5.0 OR has a triglyceride level greater than or equal to 400 OR a BMI greater than or equal to 30.0 OR a waist hip ratio greater than or equal to 0.89 OR an adjusted HsCRP level greater than or equal to 1.0, non-HDL cholesterol 210, 220 should be calculated as shown in FIGS. 5 b (for men) and 6 b (for women). If these factors do not apply, points for HDL cholesterol as shown in FIGS. 5b (for men) and 6 b (for women) are calculated.

If the individual takes medication to lower cholesterol levels 240, one point is added to the overall score 250.

Data relating to blood pressure is then evaluated and the points for blood pressure are calculated 260 as shown in FIGS. 5 c (for men) and 6 c (for women) both of which are entitled “Calculate Points for B/P (CARDIAC).” The SBP level used to calculate the points for B/P is the adjusted level resulting from risk adjustments relating to other risk factors.

Data relating to smoking status within the last 24 months is then evaluated 270. If the individual has smoked in the last 24 months, points are calculated for smoking 280 as shown in FIGS. 5 d (for men) and 6 d (for women).

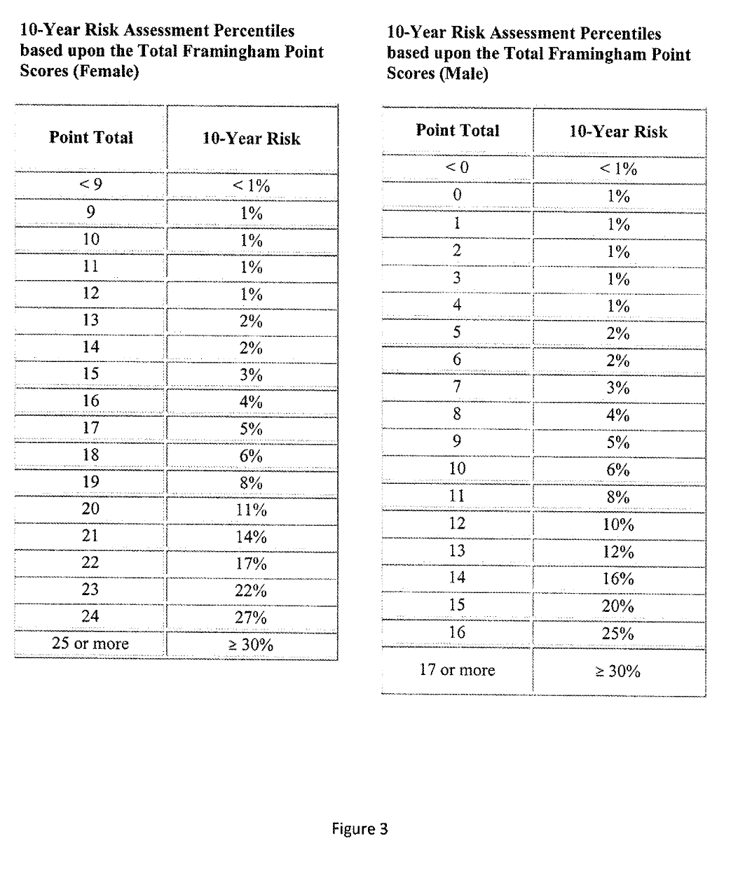

The scores for each risk factor and risk factor adjustment are then added to create an overall risk score. This overall risk score is then interpreted with the 10-Year Risk Assessment Percentiles for Males and Females as shown in FIG. 3. For example, if the overall risk score for a woman is less than 9, the woman has less than 1% risk of developing CVD within the next 10 years. Alternatively, if a woman has a woman has an overall risk score of 20, she has an 11% chance of developing CVD within the next 10 years. Likewise, a man having an overall risk score of 0 has a 1% chance of developing CVD within the next 10 years, but if he has an overall risk score of 17, his risk of developing CVD within the next 10 years is greater than or equal to 30%.

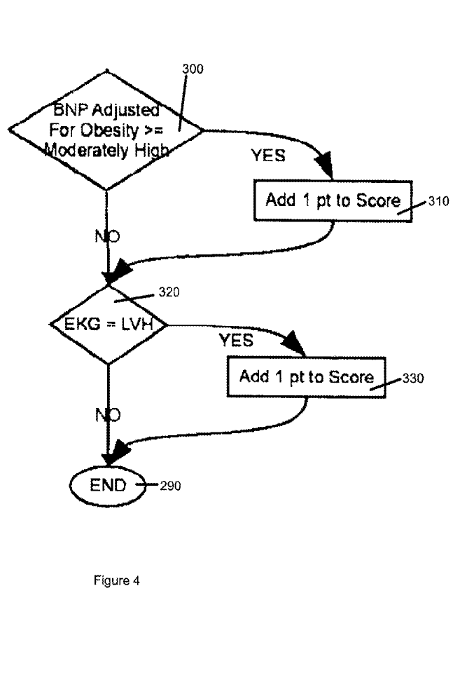

FIG. 4 provides a flow chart showing additional risk factors that for consideration in addition to the risk factors previously provided. Although optional, data relating to BNP may be evaluated 300. If the individual being assessed is obese, the overall risk score is increased by 1 point 310. In addition, data relating to an EKG may be evaluated 320. If the data is abnormal, the overall risk score is increased by 1 point 330. This adjusted overall risk score is interpreted through the 10-Year Risk Assessment Percentiles for Males and Females as shown in FIG. 3.

In addition to the method disclosed in FIGS. 2-6, additional risk factors may be considered to determine the extent of Atherosclerosis (AS) present in the individual being assessed. The overall risk score is modified by the presence and extent of AS reflected in any abnormalities on CIMT and ABI measurements. The risk level may be further modified with data from the EKG and biochemical/physiologic abnormalities reflected by MA levels BNP levels.

The adjusted risk score based upon the additional calculations will broadly be: low risk; moderate/moderately high risk; very high risk after the new values are given to the FRS.

The AS test including CIMT and ABI risk levels, will be graded as follows; no added (/) for CIMT less than 50%, or with IMT <1 mm., and no plaques in the defined field of observation: (+) for CIMT with 1 or 2 plaques or thickness greater than 50% for age. When there are more than 3 plaques and the IMT is >1 mm. (++) and when there is greater than 50% stenosis in the carotid artery, this is considered as a disease state and referral and further testing is warranted, thereby changing a screening for risk into disease detection.

Similarly, the ABI scores are (−) for score >0.9<1.4 (as higher than 1.4 may suggest non-compressible vessels such as seen in Diabetes associated atherosclerosis): (+) for ABI <0.9 and (++) for ABI of 0.6-0.8. Absent pulses or markedly reduced ABI's, often with visible skin changes, require further evaluation and repeat testing. There is a high likelihood that an ABI of <0.6 represents clinical disease but this is best left for review and reassessment. These results plus the data from the first 5 elements listed previously will result in grades as follow:

1 No disease (ND) on atherosclerosis tests (AS) and low risk (LR) from the New Score

2 ND/Moderate high risk New Score

3 ND/High or very high risk New Score

4 Either of the atherosclerosis (AS) tests “+”/LR New Score

5 Either of AS “+”/moderately high risk New Score

6 Either of AS “+”/very high risk New Score

7 Both AS tests (+) constitutes high cardiovascular risk regardless of New Score.

8 Either or both AS (++) presumably detects disease and requires repeat testing and referral.

The combination of the adjusted risk score and CIMT or ABI levels creating this graded level will then be modified by the EKG findings, degree of MA, as well as BNP results. The ECG modifier will be C_{—} with a subscript value of 1, 2 or 3. 1 is for normal, 2 is for left ventricular hypertrophy (LVH), and 3 is assigned to findings of prior infarction, ischemia or arrhythmias or other structural or major conduction abnormalities. This would prompt further reassessment and referral and may be considered as disease detection.

Similarly, the degree of MA with a modifier of A will be scored with a 1 for normal defined as less than 30 micrograms per milligram of creatinine (mcg/mgCr); a 2 for 30-299 mcg/mgCr and a 3 for greater than 300 mcg/mg Cr which is considered detection of a pathologic process and requires repeat testing and referral.

### EXAMPLE 1

A 46 year old woman presents with a BP of 136/84 has a total Cholesterol (TC) of 212 with an HDL of 42 and TG 200. She stopped smoking 1 pack per day of cigarettes 2 months ago. She has no history of diabetes. Her height is 5 foot 3 inches tall and her weight is 193 pounds giving her a BMI of 33. Her waist circumference of 37 inches and her hips measure 40 inches. Her HSCRP is 3.3, while her HbA1C is 5.6. She had gestational diabetes with both of her pregnancies, her mother had a coronary bypass at age 62 and her aunt had a stroke at 57. Both of them are diabetic. She is negative for microalbuminuria.

Her standard Framingham Risk Score (FRS) is 19 which indicates that she has an 8% chance of developing CHD within 10 years. This places her in the “Average Risk” category.

By reevaluating her risk scores through the method of the present invention, it is clear that her risk of developing cardiovascular disease is much greater than average. The method of the present invention includes data points that are not considered in the Framingham assessment, but are critical in determining the severity of her risk of developing CVD within the next 10 years.

More specifically, the adjustment of her positive family history with an A1C of >5.5<6.0 adds 2 points to her overall score and would increase her to the next level on our BP charting. It would also add a point to her HsCRP but she already is >3 which adds 2 points, so no additional points accumulate at this juncture. Her BMI of 33 in the presence of elevated CRP adds 1 point. The positive family history (FH), with central obesity and elevated HsCRP converts her to use of NonHDL cholesterol which, at 170, adds 3 points to her age-adjusted TC points. Her depressed HDL cholesterol adds 2 more points. Even shifting BP to the next level doesn't change the points from FRS so no additional points accrue at this time. Her smoking within 2 months gives her the same FRS points but now we add 1 additional point since she has at least 2 additional points relating to obesity, increased HsCRP and all five makers of Metabolic Syndrome, which are the factors used to determine if non HDL cholesterol is used in the calculation of cholesterol points. These 13 additional points added to her FRS of 19 gives her total of 32 point which places her in the very high risk group.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

We hereby claim:

1. A method of assessing the risk of developing cardiovascular disease in an asymptomatic individual comprising the steps of:
calculating the risk level of each measured cardiac risk factor;
assigning a point score corresponding to each calculated risk level for each risk factor;
calculating an overall risk score; and
translating the overall risk score into a corresponding percentage of developing cardiovascular disease within the next 10 years.

2. A computer-implemented method of assessing the risk of developing cardiovascular disease in an asymptomatic individual comprising the steps of:
calculating the risk level of each measured cardiac risk factor;
assigning a point score corresponding to each calculated risk level for each risk factor;
calculating an overall risk score; and
translating the overall risk score into a corresponding percentage of developing cardiovascular disease within the next 10 years.

3. A computer program product for use in assessing the risk of developing cardiovascular disease in an asymptomatic individual through a method comprising the steps of:
calculating the risk level of each measured cardiac risk factor;
assigning a point score corresponding to each calculated risk level for each risk factor;
calculating an overall risk score; and
translating the overall risk score into a corresponding percentage of developing cardiovascular disease within the next 10 years.
